(19) United States
(12) Patent Application Publication
(10) Pub. No.: US 2026/0234379 A1
(43) Pub. Date: Aug. 13, 2026

(54) POLYETHYLENE COMPOSITION FOR INSULATION LAYER

(71) Applicant: DOW GLOBAL TECHNOLOGIES LLC, Midland, MI (US)

(72) Inventors: Michael T. Petr, Collegeville, PA (US); Paul J. Brigandi, Collegeville, PA (US); Mohamed Esseghir, Collegeville, PA (US); Douglas S. Ginger, Lake Jackson, TX (US); Andrew T. Heitsch, Lake Jackson, TX (US); Bharat I. Chaudhary, Collegeville, PA (US); Daniel W. Baugh, III, Lake Jackson, TX (US)

(21) Appl. No.: 19/155,318

(22) PCT Filed: Feb. 5, 2024
(86) PCT No.: PCT/US2024/014383

§ 371 Date: Aug. 11, 2025

Related U.S. Application Data
(60) Provisional application No. 63/485,963, filed on Feb. 20, 2023.

(51) Int. Cl. C08L 23/0807; H01B 3/44

(52) U.S. Cl. CPC C08L 23/0815; H01B 3/441; C08L 2203/202; C08L 2312/00

(57) ABSTRACT

The present disclosure is directed to an insulation layer for a cable. In an embodiment, the insulation layer includes a silane crosslinked polyethylene composition composed of (A) from 90 wt % to 99 wt % of a base bimodal ethylene/C₄-C₈ α-olefin copolymer. The base ethylene/C₄-C₈ α-olefin copolymer, prior to silane crosslinking, has (i) a density from 0.91 g/cc to 0.93 g/cc, (ii) an I₂₁/I₂ ratio from 90 to 140, (iii) an Mw/Mn from 7.0 to 15.0, (iv) an SHI (n0.1/n100) value from 5.0 to 30.0, (v) from 0 ppb to 80 ppb boron; and (vi) from 0 ppm to 5 ppm of fluorine. The insulation layer also includes (B) from 0.5 wt % to 2.0 wt % of a hydrolyzed silane monomer. The insulation layer has a property selected from the group consisting of (1) a surface roughness Ra value from 50 μ-in to 150 μ-in, (2) a dissipation factor less than or equal to 0.0001 radians, (3) a dielectric constant from 2.0 to less than 2.29, (4) a volume resistivity from 5.00×10¹⁶ to 8.00×10¹⁷, (5) a hot creep value from 20% to 30%, and combinations thereof.

### BACKGROUND

Linear low density polyethylene (LLDPE) finds widespread application as a base resin for insulation for power cables because of several favorable features. LLDPE has a low dielectric constant, which provides good electrical insulation between conducting elements. LLDPE is readily crosslinked which provides mechanical stability for cable insulation.

One drawback to LLDPE is that it typically has a narrow molecular weight distribution (MWD) with a polydispersity less than 5.0 because it is metallocene catalyzed in a single reactor. This narrow MWD leads to a high degree of shear flow deformation when LLDPE is extruded through an annular die at high shear rate, as occurs in the production of the jacket layer of a wire or cable. The high degree of shear flow deformation leads to surface roughness for the cable insulation when LLDPE is extruded onto cable at a high rate. Surface roughness for cable insulation leads to reduced electrical performance because the surface roughness concentrates the electric fields in the cable jacket.

Chromium catalyzed olefin polymerization is known to produce LLDPE with broad MWD, which is characterized by a high melt flow ratio, and in particular, an 121/12 value of 80 or greater. On the other hand, the catalysts and the activators typically used in solution phase polymerization systems (i.e., non-chromium catalyst based) produce LLDPE with narrow molecular weight distributions (polydispersity less than 5.0), which results in a rough insulation surface during extrusion and may lead to electrical stress concentration and interfacial issues when the cable is jacketed. Moreover, in wire and/or cable-coating applications, a smooth surface is necessary for the LLDPE cable insulation to maximize electrical performance and to provide an aesthetically-acceptable consumer end-product. Thus, the art recognizes the need for polyethylene compositions, and LLDPE compositions in particular, with broad MWD and high shear thinning (i.e., I₂₁/I₂ ratio greater than 80) for good processability at high extrusion shear rates to form smooth cable insulation layers for wire and/or cable coatings while simultaneously maximizing insulative performance, such as low conductivity and high resistivity.

The present disclosure is directed to an insulation layer for a cable. In an embodiment, the insulation layer includes a silane crosslinked polyethylene composition composed of (A) from 90 wt % to 99 wt % of a base bimodal ethylene/C₄-C₈ α-olefin copolymer. The base ethylene/C₄-C₈ α-olefin copolymer, prior to silane crosslinking, has (i) a density from 0.91 g/cc to 0.93 g/cc, (ii) an I₂₁/I₂ ratio from 90 to 140, (iii) an Mw/Mn from 7.0 to 15.0, (iv) an SHI (n0.1/n100) value from 5.0 to 30.0, (v) from 0 ppb to 80 ppb boron, and (vi) from 0 ppm to 5 ppm of fluorine. The insulation layer also includes (B) from 0.5 wt % to 2.0 wt % of a hydrolyzed silane monomer. The insulation layer has a property selected from the group consisting of (1) a surface roughness Ra value from 50μ-in to 150μ-in, (2) a dissipation factor less than or equal to 0.0001 radians, (3) a dielectric constant from 2.0 to less than 2.29, (4) a volume resistivity from 5.00×10¹⁶ to 8.00×10¹⁷, (5) a hot creep value from 20% to 30%, and combinations thereof.

The present disclosure also provides a cable. In an embodiment, the cable includes a conductor and an insulation layer on the conductor. The insulation layer is composed of a silane crosslinked polyethylene composition composed of (A) from 90 wt % to 99 wt % of a base bimodal ethylene/C₄-C₈ α-olefin copolymer. The base bimodal ethylene/C₄-C₈ α-olefin copolymer prior to silane crosslinking, has (i) a density from 0.91 g/cc to 0.93 g/cc, (ii) an I₂₁/I₂ ratio from 90 to 140, (iii) an Mw/Mn from 7.0 to 15.0, and (iv) an SHI (n0.1/n100) value from 5.0 to 30.0. The insulation layer also includes from 0.5 wt % to 2.0 wt % of a hydrolyzed silane monomer.

### BRIEF DESCRIPTION OF THE DRAWINGS

FIG. 1 is a chart showing the chemical structures for different types of carbon-carbon double bonds (unsaturation in polymer chain) for vinylene, trisubstituted, vinyl, and vinylidene.

FIG. 2 is a schematic representation of the flow pattern for a two reactor polymerization system in accordance with an embodiment of the present disclosure.

### Definitions

Any reference to the Periodic Table of Elements is that as published by CRC Press, Inc., 1990-1991. Reference to a group of elements in this table is by the new notation for numbering groups.

For purposes of United States patent practice, the contents of any referenced patent, patent application or publication are incorporated by reference in their entirety (or its equivalent U.S. version is so incorporated by reference) especially with respect to the disclosure of definitions (to the extent not inconsistent with any definitions specifically provided in this disclosure).

The numerical ranges disclosed herein include all values from, and including, the lower and upper value. For ranges containing explicit values (e.g., from 1 or 2, or 3 to 5, or 6, or 7), any subrange between any two explicit values is included (e.g., the range 1-7 above includes subranges of from 1 to 2; from 2 to 6; from 5 to 7; from 3 to 7; from 5 to 6; etc.).

Unless stated to the contrary, implicit from the context, or customary in the art, all parts and percentages are based on weight and all test methods are current as of the filing date of this disclosure.

A “bimodal” polyethylene composition contains two polyethylene fractions that have been produced under different polymerization conditions, including differences in any of the process conditions and/or catalyst systems, resulting in different molecular weights and/or different comonomer contents for the fractions. The first polyethylene fraction is a high molecular weight component. The second polyethylene fraction is a low molecular weight component. The bimodal polyethylene is an in-reactor blend of the high molecular weight component and the low molecular weight component whereby one component is produced and then is present in the production of the second component.

The terms “blend” or “polymer blend,” as used, refers to a mixture of two or more polymers. A blend may or may not be miscible (not phase separated at molecular level). A blend may or may not be phase separated. A blend may or may not contain one or more domain configurations, as determined from transmission electron spectroscopy, light scattering, x-ray scattering, and other methods known in the art. The blend may be affected by physically mixing the two or more polymers on the macro level (for example, melt blending resins or compounding), or the micro level (for example, simultaneous forming within the same reactor).

The term “composition” refers to a mixture of materials which comprise the composition, as well as reaction products and decomposition products formed from the materials of the composition.

The terms “comprising,” “including,” “having” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term “consisting essentially of” excludes from the scope of any succeeding recitation any other component, step, or procedure, excepting those that are not essential to operability. The term “consisting of” excludes any component, step, or procedure not specifically delineated or listed. The term “or,” unless stated otherwise, refers to the listed members individually as well as in any combination.

An “ethylene-based polymer” is a polymer that contains more than 50 mole percent (wt %) polymerized ethylene monomer (based on the total amount of polymerizable monomers) and, optionally, may contain at least one comonomer. Ethylene-based polymer includes ethylene homopolymer, and ethylene copolymer (meaning units derived from ethylene and one or more comonomers). The terms “ethylene-based polymer” and “polyethylene” may be used interchangeably. Ethylene-based polymer may include ethylene copolymerized with an α-olefin (e.g., C₃-C₁₂ α-olefin, or C₄-C₈ α-olefin).

The term “ethylene monomer,” or “ethylene,” as used herein, refers to a chemical unit having two carbon atoms with a double bond there between, and each carbon bonded to two hydrogen atoms, wherein the chemical unit polymerizes with other such chemical units to form an ethylene-based polymer composition.

A “heteroatom” is an atom other than carbon or hydrogen. The heteroatom can be a non-carbon atom from Groups IV, V, VI and VII of the Periodic Table. Nonlimiting examples of heteroatoms include: F, N, O, P, B, S, and Si.

A “hydrocarbon” is a compound containing only hydrogen atoms and carbon atoms. A hydrocarbon can have a linear structure, a cyclic structure, or a branched structure.

“Linear low-density polyethylene” (or “LLDPE”) is a linear ethylene/α-olefin copolymer containing heterogeneous short-chain branching distribution comprising units derived from ethylene and units derived from at least one C₃-C₁₀ α-olefin comonomer or at least one C₄-C₈ α-olefin comonomer, or at least one C₆-C₈ α-olefin comonomer. LLDPE is characterized by little, if any, long chain branching, in contrast to conventional LDPE. LLDPE has a density from 0.910 g/cc to 0.940 g/cc, or from 0.910 g/cc to 0.930 g/cc, or from 0.915 g/cc to 0.930 g/cc, or from 0.915 g/cc to 0.925 g/cc.

“Low density polyethylene” (or “LDPE”) consists of ethylene homopolymer, or ethylene copolymer with acrylate, vinyl acetate, and/or vinyl silane as comonomer, the LDPE has a density from 0.915 g/cc to 0.940 g/cc and contains long chain branching with broad molecular weight distribution (MWD). LDPE is typically produced by way of high pressure free radical polymerization (tubular reactor or autoclave with free radical initiator). Nonlimiting examples of LDPE include LDPE products from Chevron Phillips (MarFlex™), LyondellBasell (LUPOLEN™), Borealis, Ineos, ExxonMobil, and others.

An “olefin” is an unsaturated, aliphatic hydrocarbon having a carbon-carbon double bond.

An “olefin-based polymer” (interchangeably referred to as “polyolefin”) is a polymer that contains a majority weight percent of polymerized olefin monomer (based on the total amount of polymerizable monomers), and optionally, may contain at least one comonomer. Nonlimiting examples of olefin-based polymer include ethylene-based polymer and propylene-based polymer.

The term “polymer” or a “polymeric material,” as used herein, refers to a compound prepared by polymerizing monomers, whether of the same or a different type, that in polymerized form provide the multiple and/or repeating “units” or “mer units” that make up a polymer. The generic term polymer thus embraces the term homopolymer, usually employed to refer to polymers prepared from only one type of monomer, and the term copolymer, usually employed to refer to polymers prepared from at least two types of monomers. It also embraces all forms of copolymer, e.g., random, block, etc. The terms “ethylene/α-olefin polymer” and “propylene/α-olefin polymer” are indicative of copolymer as described above prepared from polymerizing ethylene or propylene respectively and one or more additional, polymerizable α-olefin monomer. It is noted that although a polymer is often referred to as being “made of” one or more specified monomers, “based on” a specified monomer or monomer type, “containing” a specified monomer content, or the like, in this context the term “monomer” is understood to be referring to the polymerized remnant of the specified monomer and not to the unpolymerized species. In general, polymers herein are referred to as being based on “units” that are the polymerized form of a corresponding monomer.

A “sheath” when used in relation to cables includes insulation coverings or layers, protective jackets and the like.

A “wire” is a single strand of conductive metal, e.g., copper or aluminum, or a single strand of optical fiber.

### Test Methods

¹³C NMR. ¹³C nuclear magnetic resonance (¹³C NMR) is used to determine the type and amount of short chain branching, i.e., comonomer, in the polymer. Samples for ¹³C NMR were prepared by adding approximately 3 g of 1,1,2,2-tetrachloroethane (TCE) containing 25 wt % TCE-d2 and 0.025 M Cr(AcAc)₃, to about 0.10 g polymer sample, in a 10 mm NMR tube. The samples were dissolved and homogenized by heating the tube and its contents to 135° C. using a heating block and vortex mixer. Each dissolved sample was visually inspected to ensure homogeneity. Samples were thoroughly mixed immediately prior to analysis and were not allowed to cool before insertion into the heated NMR sample holders. All data were collected using a Bruker 600 MHz spectrometer equipped with a 10 mm high temperature cryoprobe. The ¹³C data was acquired using a 7.8 second pulse repetition delay, 90-degree flip angles, and inverse gated decoupling, with a sample temperature of 120° C. All measurements were made on non-spinning samples in locked mode. Samples were allowed to thermally equilibrate prior to data acquisition. The ¹³C NMR chemical shifts were internally referenced to the EEE triad at 30.0 ppm. Composition was determined using the assignments from Liu, W.; Rinaldi, P. L.; Mcintosh, L. H.; and Quirk, R. P.; Macromolecules, 34, 2001, 4757-4767 (for ethylene-co-octene polymer), and Sahoo, S. K., et al., Macromolecules 36, 2003, 4017-4028 (for ethylene-co-butene polymer) and integrated ¹³C NMR spectra to solve the vector equation s=fM where M is an assignment matrix, s is a row vector representation of the spectrum, and f is a mole fraction composition vector. The elements of f were taken to be triads of E and O (octene) or B (butene) with all permutations of E and O or B. The assignment matrix M was created with one row for each triad in f and a column for each of the integrated NMR signals. The elements of the matrix were integral values determined by reference to the assignments in (Liu, W.; Rinaldi, P. L.; McIntosh, L. H.; and Quirk, R. P.; Macromolecules, 34, 2001, 4757-4767), or Sahoo, S. K., et al., Macromolecules 36, 2003, 4017-4028. The equation was solved by variation of the elements of f as needed to minimize the error function between s and the integrated ¹³C data for each sample. This is executed in Microsoft Excel by using the Solver function.

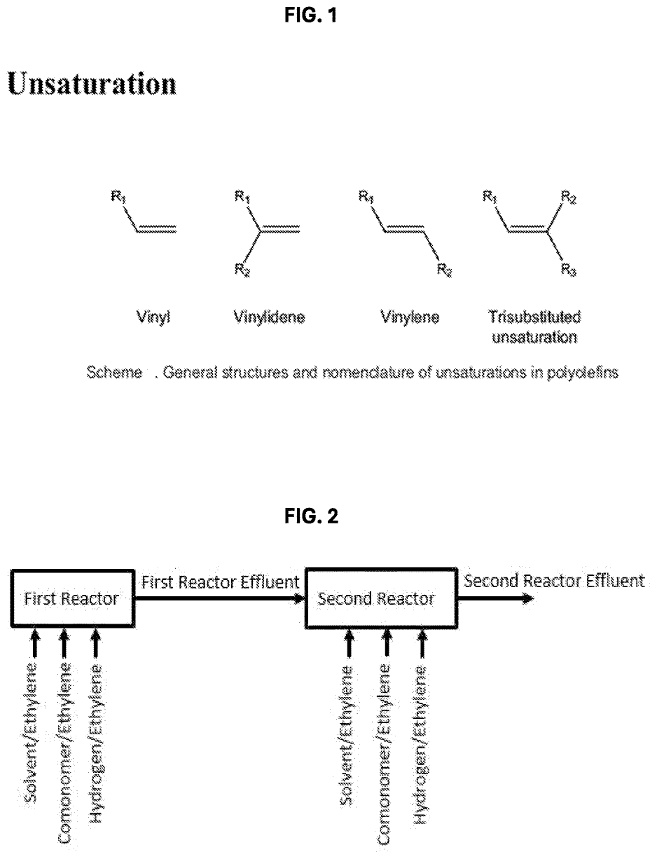

¹H NMR. ¹H nuclear magnetic resonance (1H NMR) was used to quantitate the following types of carbon-carbon double bonds (“unsaturations”) in the polymer. “Vinylene” is a carbon-carbon double bond with the formula R₁—CH═CH—R₂, wherein R₁ and R₂ are each one or more carbon atoms with attached hydrogen atoms. “Trisubstituted” is a carbon-carbon double bond in which the doubly bonded carbons are bonded to a total of three carbon atoms and wherein R₁, R₂ and R₃ (in FIG. 1) each is a carbon atom. “Vinyl” is a carbon-carbon double bond with the formula R—CH═CH₂, wherein R is a carbon atom. “Vinylidene” is a carbon-carbon double bond with the formula R₁(R₂)C═CH₂ where-in R₁ and R₂ are each one or more carbon atoms with attached hydrogen atoms. “Total unsaturation (or “total”) is the sum of vinylene, trisubstituted, vinyl, and vinylidene in a polymer. The chemical structures for vinylene, trisubstituted, vinyl, and vinylidene are provided in FIG. 1. Samples for 1H NMR were prepared by adding approximately 3 g of a 50/50 mixture of 1,1,2,2-tetrachloroethane (TCE-d2) and perchloroethylene (PCE) containing 0.001 M Cr(AcAc)₃, to about 0.10 g polymer sample, in a 10 mm NMR tube. The 1H NMR was performed on a Bruker 600 MHz spectrometer equipped with a 10 mm high temperature cryoprobe and a sample temperature of 120° C. Two experiments were run to obtain spectra, a control spectrum to quantitate the total polymer protons, and a double presaturation experiment, which suppresses the intense polymer backbone peaks and enables high sensitivity spectra for quantitation of the end-groups. The control was run with ZG pulse, 16 scans, AQ 1.64s, D1 14s. The double presaturation experiment was run with a modified pulse sequence, 64 scans, AQ 1.64s, presaturation delay 2s, relaxation delay 12s.

Density was measured in accordance with ASTM D792, Method B. The result is recorded in grams per cubic centimeter (g/cc).

Dielectric constant and dissipation factor were measured following D924-08 at 2.47 GHZ using a High Frequency Resonant Cavity.

Dynamic Mechanical Spectroscopy (DMS). DMS is used to measure polymer melt viscosity. Resins were compression-molded into “3 mm thick×1 inch” circular plaques at 350° F., for five minutes, under 25000 psi pressure, in air. The sample was then taken out of the press and placed on a counter to cool. A constant temperature frequency sweep was performed using a TA Instruments “Advanced Rheometric Expansion System (ARES),” equipped with 25 mm (diameter) parallel plates, under a nitrogen purge. The sample was placed on the plate, and allowed to melt for five minutes at 190° C. The plates were then closed to a gap of “2 mm,” the sample trimmed (extra sample that extends beyond the circumference of the “25 mm diameter” plate was removed), and then the test was started. The method had an additional five minute delay built in to allow for temperature equilibrium. The experiments were performed at 190° C. over a frequency range of 0.1 to 100 (radians/second). The strain amplitude was constant at 10%. The complex viscosity η*, tan (8) or tan delta, viscosity at 0.1 radians/second (V0.1), the viscosity at 100 rad/s (V100), and the viscosity ratio (V0.1/V100) were calculated from these data.

Elemental analysis. Boron elemental analysis was determined using Inductively Coupled Plasma-Optical Emission Spectrometry (ICP-OES). The samples were prepared for ICP metals analysis, in duplicate, by weighing 0.25 grams (nominal) into 15-mL Teflon test tubes and adding 1-milliliter (mL) of de-ionized water, 2-mL of concentrated nitric acid and 0.15 mL hydrofluoric acid. The tubes were then placed into a Milestone Ultrawave closed vessel microwave digestion system and digested at 240° C. for 30 minutes. After digestion, the samples were removed from the microwave and diluted to a final volume of ten milliliters using de-ionized water. The samples were transferred into autosampler test tubes and were ready for ICP-MS analysis.

The prepared solutions were analyzed using inductively coupled plasma mass spectroscopy (ICP-MS) using an Agilent 7900x. The instrument was calibrated over the range of 0-10 ng/ml using 0, 0.5, 1.0, 5.0 and 10 ng/ml calibration standards (SPEX CertiPrep, Multi-element Standards) made up in 5% nitric acid and 1.5% hydrofluoric acid. The instrument operating conditions used for this analysis are shown in Error! Reference source not found. below. Where possible, multiple isotopes of the analytes were monitored in no gas, hydrogen, and helium mode. This was done in case there may have been any interferences from the sample matrix.

TABLE A
Agilent 7900x ICP-MS Instrument Operating Conditions.
Shield Torch with 1.5 mm injector
PFA Teflon Sample Introduction System and Spray Chamber
Platinum Cones

| | No Gas | | Hydrogen | | Helium | |
|---|---|---|---|---|---|---|
| | Mode | | Mode | | Mode | |
| RF power | 1550 | W | 1550 | W | 1550 | W |
| RF matching | 1.50 | V | 1.50 | V | 1.50 | V |
| Sampling Depth | 8.0 | mm | 8.0 | mm | 8.0 | mm |
| Carrier Gas | 0.84 | L/min | 0.84 | L/min | 0.84 | L/min |
| Makeup Gas | 0.10 | L/min | 0.10 | L/min | 0.10 | L/min |
| Peristaltic Pump | 0.10 | rps | 0.10 | rps | 0.10 | rps |
| Spray Chamber | 2° | C. | 2° | C. | 2° | C. |

| | | | | | |
|---|---|---|---|---|---|
| Reaction Cell Gas | — | 4.0 | mL/min | 4.0 | mL/min |

All other elements were determined using Neutron Activation Analysis (“NAA”). Duplicate samples were prepared by transferring approximately 3.5 grams of the resins into pre-cleaned 2-dram polyethylene vials. Duplicate fluorine standards were prepared from a NIST fluoro-benzoic acid standard into similar vials. The fluorine standards were diluted to 6 ml with 2-propanol and heat sealed. Similarly, Mg, Al, Ti, Hf, Cr and Zr standards were prepared from their standard solutions (Certi. pure from SPEX) into 2-dram polyethylene vials. They were diluted using milli-Q pure water to 6 ml and the vials were heat-sealed. The samples and standards were then analyzed following the standard NAA procedure, Global-SOP-01101.02 for these elements, using the Dow Mark I TRIGA nuclear reactor. For Mg, Al, Ti, Hf, Cr and Zr analysis, the samples were transferred to un-irradiated vials before doing the gamma-spectroscopy. For the fluorine, background contributions were addressed by using clean vials and making multiple runs with different vials. The reactions and experimental conditions used for the elements are summarized in Table BB. The elemental concentrations were calculated using Canberra™ software and standard comparative technique.

TABLE B
Reactions and experimental conditions used for some of the elements during the NAA

| | | | | | | | | | | | | Zirconium | |
|---|---|---|---|---|---|---|---|---|---|---|---|---|---|
| Element | Fluorine | Aluminum | | Magnesium | | Titanium | | Chromium | | Hafnium | | ⁹⁶Zr(n, | |
| Reaction | ¹⁹F(n, y)²⁰F | ²⁷Al(n, y)²⁸Al | | ²⁶Mg(n, y)²⁷Mg | | ⁵⁰Ti(n, y)⁵¹Ti | | ⁵⁰Cr(n, y)⁵¹Cr | | ¹⁸⁰Hf(n, y)¹⁸¹Hf | | v)⁹⁷Zr | |
| Half-life | 11 sec | 2.25 | min | 9.4 | min | 5.79 | min | 27.71 | days | 42.5 | days | 16.8 | hrs |
| Reactor | 250 kW | 250 | kW | 250 | kW | 250 | kW | 250 | kW | 250 | kW | 250 | kW |
| power | | | | | | | | | | | | | |
| Irradiation | 15 sec | 2 | min | 2 | min | 2 | min | 180 | min | 180 | min | 180 | min |
| time | | | | | | | | | | | | | |
| Waiting | 10 sec | 6 | min | 6 | min | 6 | min | 5 | hr | 5 | hr | 5 | hr |
| time | | | | | | | | | | | | | |
| Counting | 20 sec | 270 | sec | 270 | sec | 270 | sec | 5 | hr | 5 | hr | 5 | hr |
| time | | | | | | | | | | | | | |
| Gamma | 1633 keV | 1779 | keV | 843,1014 | keV | 928.5 | keV | 320 | keV | 133,482 | keV | 743 | keV |
| Energy | | | | | | | | | | | | | |

Gel permeation chromatography. The average molecular weights and molecular weight distributions for ethylene based polymers were determined with gel permeation chromatography (GPC). The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all absolute Light scattering measurements, the 15 degree angle was used for measurement. The autosampler oven compartment was set at 160° Celsius and the column and detector compartment were set at 150° Celsius. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.43 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° Celsius under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} {IR}_{i}}{{\sum }^{i} ( {IR}_{i} / {M}_{{polyethylene}_{i}} )} \qquad ( EQ 2 )$$

$${Mw}_{( GPC )} = \frac{{\sum }^{i} ( {IR}_{i} * {M}_{{polyethylene}_{i}} )}{{\sum }^{i} {IR}_{i}} \qquad ( EQ 3 )$$

$${Mz}_{( GPC )} = \frac{{\sum }^{i} ( {IR}_{i} * {M}_{{polyethylene}_{i}}^{2} )}{{\sum }^{i} ( {IR}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate (nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate (effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

$$Flowrate ( effective ) = Flowrate ( nominal ) * ( R V ( F M Calibrated ) / RV ( FM Sample ) ) \qquad ( EQ 5 )$$

Hot creep was measured at 200° C. for 15 minutes according to ICEA T-28-562. The percent elongation of the sample from its initial value is recorded after exposure in the oven for 15 minutes without removing the sample from the oven.

Melt Index. The term “melt index,” or “MI” as used herein, refers to the measure of how easily a thermoplastic polymer flows when in a melted state. Melt index, or “I₂,” is measured in accordance by ASTM D 1238 Method A, Condition 190° C./2.16 kg, and is reported in grams eluted per 10 minutes (g/10 min). The “I₂₁” value is measured in accordance with ASTM D 1238 Method A, Condition 190° C./21.6 kg, and is reported in grams eluted per 10 minutes (g/10 min). A melt flow rate ratio, “I₂₁/I₂,” is calculated from these individual values by dividing the I₂₁ value by the I₂ value. The melt flow rate ratio is dimensionless.

Shear thinning index (SHI) was calculated as the ratio of the dynamic viscosity measured at 0.1 rad/s to that at 100 rad/s and 190° C.

Surface roughness. Cable jacket surface roughness was evaluated by the average surface roughness, Ra, as measured using a Mitutoyo Surftest SJ-400 surface roughness tester. Results are reported in micro-inches or μ-in.

Volume resistivity (or resistivity) was measured in accordance with ASTM D257-07 utilizing 50 mil plaques using a Hewlett-Packard High Resistance Meter. Results are reported in ohm/cm.

### DETAILED DESCRIPTION

The present disclosure provides an insulation layer. In an embodiment, the insulation layer includes a silane crosslinked polyethylene composition. The silane crosslinked polyethylene composition includes (A) from 90 wt % to 99 wt % of a base bimodal ethylene/C₄-C₈ α-olefin copolymer. The base bimodal ethylene/C₄-C₈ α-olefin copolymer prior to silane crosslinking, has one, some, or all of the following properties: (i) a density from 0.910 g/cc to 0.930 g/cc, (ii) an I₂₁/I₂ ratio from 90 to 140, (iii) an Mw/Mn from 7.0 to 15.0, and (iv) an SHI (n0.1/n100) value from 5.0 to 30.0. The silane crosslinked polyethylene composition also includes (B) from 0.5 wt % to 2.0 wt % of a hydrolyzed silane monomer. The insulation layer has a property selected from one, some, or all of the following properties: (1) a surface roughness/roughness Ra value from 50μ-in to 150μ-in, (2) a dissipation factor less than or equal to 0.0001 radians, (3) a dielectric constant from 2.0 to less than 2.29, (4) a volume resistivity from 5.00 E+16 to 8.00 E+17, and (5) a hot creep value from 20% to 30%.

The present composition includes a silane crosslinked polyethylene. The silane crosslinked polyethylene includes a base bimodal ethylene/C₄-C₈ α-olefin copolymer. The “base bimodal ethylene/C₄-C₈ α-olefin copolymer,” as used herein, refers to the ethylene/C₄-C₈ α-olefin copolymer prior to the ethylene/C₄-C₈ α-olefin copolymer being silane crosslinked. The term “base” and “prior to crosslinking” when referring to the bimodal ethylene/C₄-C₈ α-olefin copolymer are used interchangeably.

1. Bimodal Ethylene/C₄-C₈ α-Olefin Copolymer

The present composition includes a base bimodal ethylene/C₄-C₈ α-olefin copolymer. The “base bimodal ethylene/C₄-C₈ α-olefin copolymer,” as used herein, refers to the ethylene/C₄-C₈ α-olefin copolymer prior to the ethylene/C₄-C₈ α-olefin copolymer being crosslinked.

The base ethylene/α-olefin copolymer is a bimodal ethylene/α-olefin copolymer. The α-olefin is a C₃-C₂₀ comonomer, or C₄-C₈ comonomer. Nonlimiting examples of suitable α-olefin comonomer include butene, hexene, and octene. A “bimodal ethylene/α-olefin copolymer” is an ethylene/C₄-C₈ α-olefin copolymer that has two distinct populations, which often exhibit two peaks on a GPC curve. These distributions are viewed statistically, that is, as statistical distributions. Thus, where there is one peak, the distribution has one mode and is unimodal. Two peaks are bimodal. Two or more peaks are multimodal. In an embodiment, the bimodal ethylene/C₄-C₈ α-olefin copolymer has a high molecular weight portion and a low molecular weight portion thereby defining “a bimodal molecular weight distribution.” The “high molecular weight portion” of the bimodal ethylene/α-olefin copolymer has a Mw from 100,000 g/mol to 1,000,000 g/mol, the “low molecular weight portion” of the bimodal ethylene/α-olefin copolymer has a Mw from 1,000 g/mol to less than 100,000 g/mol. The bimodal ethylene/α-olefin copolymer has a Mw/Mn from 7.0 to 15.0, or from 7.0 to 13.0, or from 7.1 to 12.0. In an embodiment, the bimodal ethylene/C₄-C₈ α-olefin is an ethylene/octene copolymer.

In an embodiment, the base bimodal ethylene/C₄-C₈ α-olefin copolymer is produced in a solution polymerization process. A “solution polymerization process,” refers to one or more continuous solution polymerization reactors, operating under polymerization conditions, wherein the polymer (e.g., polyethylene) is formed in a liquid polymerization solvent to which monomer (e.g., ethylene) and comonomers (e.g., C₃-C₂₀ α-olefin, or C₄-C₈ α-olefin) along with catalyst/cocatalyst (activator) are added. The term “polymerization conditions,” as used herein, refer to process parameters under which ethylene and comonomer are copolymerized in the presence of a catalyst system. Polymerization conditions include, for example, polymerization reactor conditions (reactor type), reactor pressure, reactor temperature, concentrations of reagents and polymer, solvent, carrier, residence time and distribution, influencing the molecular weight distribution and polymer structure.

In an embodiment, the base bimodal ethylene/α-olefin copolymer is produced in a two-reactor solution polymerization system whereby the effluent from a first solution polymerization reactor flows into a second solution polymerization reactor. A first catalyst and cocatalyst (or first activator) are injected into the first solution polymerization reactor and a second catalyst and cocatalyst (or second activator) are injected into the second solution polymerization reactor. The first catalyst and the second catalyst each is void of, or otherwise excludes chromium. The first cocatalyst and the second cocatalyst each is void of, or otherwise exclude boron and fluorine. Some boron and/or fluorine species are known to be detrimental to the insulative properties for coated conductors.

In an embodiment, a two-reactor solution polymerization system is used to produce the base bimodal ethylene/α-olefin copolymer as an ethylene/C₄-C₈ α-olefin copolymer, or ethylene/octene copolymer having one, some, or all of the following properties:
(i) a density from 0.910 g/cc to 0.930 g/cc, or from 0.915 to 0.925 g/cc; and/or
(ii) an I₂₁/I₂ ratio from 90 to 140, or from 92 to 135, or from 93 to 130; and/or
(iii) an Mw/Mn from 7.0 to 15.0, or from 7.0 to 13.0, or from 7.1 to 12.0; and/or
(iv) an Mz less than 600,000 g/mol, or from 100,000 g/mol to 500,000 g/mol, or from 200,000 g/mol to 400,000 g/mol, or from 300,000 g/mol to 400,000 g/mol; and/or
(v) an SHI value (n0.1/100) from 5.0 to 30.0, or from 7.0 to 28, or from 8.0 to 27, or from 9.0 to 23.0; and/or
(vi) 0 parts per billion (ppb), or from greater than 0 ppb to 80 ppb, or from 1 ppb to 50 ppb boron;
(vii) 0 parts per million (ppm), or from greater than 0 ppm to 5 ppm, or from 1 ppm to 3 ppm fluorine; and/or
(viii) 0 ppb chromium or from greater than 0 ppb to less than 100 ppb chromium; and/or
(ix) an 12 value from 0.6 g/10 min to 1.2 g/10 min, or from 0.7 g/10 min to 1.1 g/10 min; and/or
(x) a terminal vinyl content from 0.22/1000 carbon atoms (1000C) to 0.70/1000C, or from 0.22/1000C to 0.50/1000, or from 0.23/1000C to 0.4/1000C; and/or
(xi) a total unsaturation from 0.25/1000C to 1.0/1000C, or from 0.25/1000C to 0.45/1000C, or from 0.25/1000C to 0.40/1000C (hereafter composition1).

The insulation layer contains from 90 wt % to 99 wt %, or from 91 wt % to 95 wt % of the base ethylene/C₄-C₈ α-olefin copolymer.

### 2. Silane Crosslinking

The silane crosslinked polyethylene composition also includes a hydrolyzable silane monomer.

The base bimodal ethylene/C₄-C₈ α-olefin copolymer is crosslinked by a reactive unsaturated silane compound, and a moisture cure catalyst (interchangeably referred to as “crosslinkable polyethylene composition”). Nonlimiting examples of silane crosslinking processes include the MONOSIL process.

In an embodiment, the base bimodal ethylene/C₄-C₈ α-olefin copolymer, free radical initiator, reactive silane compound, and moisture cure catalyst (a.k.a. silanol condensation catalyst) are fed into an extruder and melt extruded in a desired form, such as an insulation layer for wire or cable, followed by heat and/or moisture cure.

In an embodiment, the free radical initiator is an organic peroxide. Nonlimiting examples of suitable organic peroxides include mono-functional peroxides and di-functional peroxides. As used herein, “mono-functional peroxides” denote peroxides having a single pair of covalently bonded oxygen atoms (e.g., having a structure R—O—O—R). As used herein, “di-functional peroxides” denote peroxides having two pairs of covalently bonded oxygen atoms (e.g., having a structure R—O—O—R—O—O—R). In an embodiment, the organic peroxide is a mono-functional peroxide. Exemplary organic peroxides include dicumyl peroxide (“DCP”); tert-butyl peroxybenzoate; di-tert-amyl peroxide (“DTAP”); bis(t-butyl-peroxy isopropyl)benzene (“BIM”); isopropylcumyl t-butyl peroxide; t-butylcumylperoxide; di-t-butyl peroxide; 2,5-bis(t-butylperoxy)-2,5-dimethylhexane; 2,5-bis(t-butylperoxy)-2,5-dimethylhexyne-3; 1,1-bis(t-butylperoxy) 3,3,5-trimethylcyclohexane; isopropylcumyl cumylperoxide; butyl 4,4-di(tert-butylperoxy) valerate; di(isopropylcumyl) peroxide; and mixtures of two or more thereof. In various embodiments, only a single type of organic peroxide is employed. In an embodiment, the organic peroxide is dicumyl peroxide. The organic peroxide can be present in the crosslinkable polyethylene composition in an amount from 0.05 wt % to 5 wt %, or from 0.07 to 3 wt %, from 0.07 to 1.5 wt %, from 0.1 to 0.5 wt %, or from 0.1 wt % to 0.4 wt % based on the entire weight of the crosslinkable polyethylene composition.

In an embodiment, the reactive unsaturated silane compound is a hydrolyzable silane monomer. The hydrolyzable silane monomer has a hydolyzable silane group. A “hydrolyzable silane group” and like terms is a silane group that will react with water. These include alkoxysilane groups on monomers or polymers that can hydrolyze to yield silanol groups, which in turn can condense to crosslink the monomers or polymers. The ethylene/C₄-C₈ α-olefin copolymer is crosslinked by functionalization with the hydrolyzable silane group. The hydrolyzable silane group, in the presence of water, will undergo hydrolysis and condensation reactions to generate Si—O—Si bonds to form a crosslinking network between the ethylene/C₄-C₈ α-olefin copolymer chains (a.k.a., moisture crosslinking or moisture curing). Functionalization of the ethylene/C₄-C₈ α-olefin copolymer can be accomplished by either copolymerizing a monomer having a hydrolyzable silane group with the above-described ethylene and comonomers or by grafting a hydrolyzable silane group to the backbone of the ethylene-based interpolymer in a post-reactor process.

In an embodiment, hydrolyzable silane monomer has Structure (1)

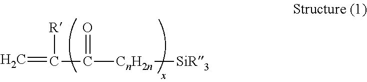

wherein R′ is a hydrogen atom or a methyl group;
x is 0 or 1;
n is an integer from 1 to 12 inclusive, or from 1 to 4, and each R″ independently is a hydrolyzable organic group such as an alkoxy group having from 1 to 12 carbon atoms (e.g. methoxy, ethoxy, butoxy), an aryloxy group (e.g. phenoxy), an aryloxy group (e.g. benzyloxy), an aliphatic acyloxy group having from 1 to 12 carbon atoms (e.g. formyloxy, acetyloxy, propanoyloxy), an amino or substituted amino group (alkylamino, arylamino), or a lower-alkyl group having 1 to 6 carbon atoms inclusive, with the proviso that not more than one of the three R″ groups is an alkyl.

In an embodiment, the hydrolyzable silane monomer is grafted to the base ethylene/C₄-C₈ α-olefin copolymer by the use of a suitable quantity of organic peroxide and moisture cure catalyst. Suitable hydrolysable silane monomer include unsaturated silanes that comprise an ethylenically unsaturated hydrocarbyl group, such as a vinyl, allyl, isopropenyl, butenyl, cyclohexenyl or gamma (meth)acryloxy allyl group, and a hydrolyzable group, such as, for example, a hydrocarbyloxy, hydrocarbonyloxy, or hydrocarbylamino group. Examples of hydrolyzable groups include methoxy, ethoxy, formyloxy, acetoxy, proprionyloxy, and alkyl or arylamino groups. Preferred silanes are the unsaturated alkoxy silanes which can be grafted onto the polymer or copolymerized in-reactor with other monomers (such as ethylene and acrylates). These silanes and their method of preparation are more fully described in U.S. Pat. No. 5,266,627 to Meverden, et al. Suitable hydrolyzable silane monomers include, but are not limited to, vinyltrimethoxysilane (“VTMS”), vinyltriethoxysilane (“VTES”), vinyltriacetoxysilane, and gamma-(meth)acryloxy propyl trimethoxy silane. The hydrozylable silane monomer constitutes from 0.2 wt % to 10 wt %, or from 0.5 wt % to 5.0 wt %, or from 1.0 wt % to 3.0 wt %, or from 1.0 wt % to 1.5 wt % of the crosslinkable polyethylene composition, wt % is based on total weight of the crosslinkable polyethylene composition.

In an embodiment, the hydrolysable silane monomer undergoes hydrolysis and condensation in the presence of water to form Si—O—Si bonds between polymer chains. Upon hydrolysis, the hydrolyzable silane monomer becomes “a hydrolyzed silane monomer,” and then condensation forms a crosslinked network between polymer chains, thereby forming the “silane crosslinked polyethylene composition.”

In an embodiment, the peroxide-initiated reaction of vinyl trimethoxysilane and base bimodal ethylene/C₄-C₈ α-olefin copolymer yields a grafted polymer having a polyethylene backbone structure with pendant ethyltrimethoxysilyl moieties. In the crosslinking reaction, methoxy groups are hydrolyzed to form methanol and pendant ethyldimethoxysilanolyl groups, which undergo condensation reactions with other ethyldimethoxysilanolyl groups to eliminate water and form an Si—O—Si linkage between the pendant silyl moieties, forming the silane crosslinked polyethylene composition. The moisture cure catalyst may be included in a catalyst masterbatch blend with the catalyst masterbatch being included in the crosslinkable polyethylene composition. Nonlimiting examples of suitable catalyst masterbatches include those sold under the trade name SI-LINK™ from The Dow Chemical Company, including SI-LINK™ DFDA-5481 Natural and SI-LINK™ AC DFDA-5488 NT. In an embodiment, the crosslinkable polyethylene composition contains from 0.001 wt %, or 0.01 wt %, or 0.5 wt %, or 1.0 wt %, or 2.0 wt %, or 3.0 wt %, or 4.0 wt % to 5.0 wt %, or 6.0 wt %, or 7.0 wt %, or 8.0 wt %, or 9.0 wt %, or 10.0 wt % moisture cure catalyst masterbatch, based on total weight of the polymeric composition. The silane grafted base bimodal ethylene/C₄-C₈ α-olefin copolymer is cured in a water bath to form the silane crosslinked polyethylene composition. In an embodiment, the moisture cure catalyst is dibutyltin dilaurate.

In an embodiment, the insulation layer includes
a silane crosslinked polyethylene composition composed of
(A) from 90 wt % to 99 wt %, or from 91 wt % to 95 wt % of a base bimodal ethylene/C₄-C₈ α-olefin copolymer, the base bimodal ethylene/C₄-C₈ α-olefin copolymer prior to silane crosslinking, having one, some, or all of the following properties:
   (i) a density from 0.910 g/cc to 0.930 g/cc, or from 0.915 to 0.925 g/cc; and/or
   (ii) an I₂₁/I₂ ratio from 90 to 140, or from 92 to 135, or from 93 to 130; and/or
   (iii) an Mw/Mn from 7.0 to 15.0, or from 7.0 to 13.0, or from 7.1 to 12.0; and/or
   (iv) an Mz less than 600,000 g/mol, or from 100,000 g/mol to 500,000 g/mol, or from 200,000 g/mol to 400,000 g/mol, or from 300,000 g/mol to 400,000 g/mol; and/or
   (v) an SHI value (n0.1/n100) from 5.0 to 30.0, or from 7.0 to 28, or from 8.0 to 27, or from 9.0 to 23.0; and/or
   (vi) 0 parts per billion (ppb), or from greater than 0 ppb to 80 ppb, or from 1 ppb to 50 ppb boron;
   (vii) 0 parts per million (ppm), or from greater than 0 ppm to 5 ppm, or from 1 ppm to 3 ppm fluorine; and/or
   (viii) 0 ppm chromium or from greater than 0 ppb to less than 100 ppb chromium; and or
   (ix) an I₂ value from 0.6 g/10 min to 1.2 g/10 min, or from 0.7 g/10 min to 1.1 g/10 min; and/or
   (x) a terminal vinyl content from 0.22/1000 carbon atoms (1000C) to 0.70/1000C, or from 0.22/1000C to 0.50/1000, or from 0.23/1000C to 0.4/1000C; and/or
   (xi) a total unsaturation from 0.25/1000C to 1.0/1000C, or from 0.25/1000C to 0.45/1000C, or from 0.25/1000C to 0.40/1000C (hereafter composition1);
(B) from 0.5 wt % to 2.0 wt %, or from 1.0 wt % to 1.5 wt % of a hydrolyzed silane monomer (such as VTMS, for example), and
   the insulation layer has one, some, or all of the following properties:
   (1) a surface roughness Ra value from 50μ-in to 150μ-in, or from 52μ-in to 125μ-in; and/or
   (2) a dissipation factor less than or equal to 0.0001 radians; and/or
   (3) a dielectric constant from 2.0 to less than 2.29; and/or
   (4) a volume resistivity from 5.00×10¹⁶ to 8.0×10¹⁷, or from 8.0×10¹⁶ to 6.0×10¹⁷; and/or
   (5) a hot creep value from 20% to 30%, or from 21% to 26%.

In an embodiment, the catalyst of composition1 is from a catalyst masterbatch and the insulation layer includes from 3 wt % to 6 wt % of a second polyethylene (the carrier resin of the catalyst masterbatch), based on total weight of the insulation layer. The second polyethylene is LLDPE, LDPE, and combinations thereof.

The insulation layer may include one or more optional additives. When present, nonlimiting examples of suitable additive include antioxidants, colorants, corrosion inhibitors, lubricants, moisture cure catalysts, ultraviolet (UV) absorbers or stabilizers, anti-blocking agents, coupling agents, compatibilizers, plasticizers, fillers, processing aids, and combinations thereof.

### 3. Cable

The present disclosure provides a cable. In an embodiment, the cable includes (i) a conductor and (ii) an insulation layer on the conductor. The insulation layer includes the silane crosslinked polyethylene composition composed of
(A) from 90 wt % to 99 wt %, or from 91 wt % to 95 wt % of a base bimodal ethylene/C₄-C₈ α-olefin copolymer, the base bimodal ethylene/C₄-C₈ α-olefin copolymer prior to silane crosslinking, having one, some, or all of the following properties:
(i) a density from 0.910 g/cc to 0.930 g/cc, or from 0.915 g/cc to 0.925 g/cc; and/or
(ii) an I₂₁/I₂ ratio from 90 to 140, or from 92 to 135, or from 93 to 130; and/or
(iii) an Mw/Mn from 7.0 to 15.0, or from 7.0 to 13.0, or from 7.1 to 12.0; and/or
(iv) an Mz less than 600,000 g/mol, or from 100,000 g/mol to 500,000 g/mol, or from 200,000 g/mol to 400,000 g/mol, or from 300,000 g/mol to 400,000 g/mol; and/or
(v) an SHI value (n0.1/n100) from 5.0 to 30.0, or from 7.0 to 28, or from 8.0 to 27, or from 9.0 to 23.0; and/or
(vi) 0 parts per billion (ppb), or from greater than 0 ppb to 80 ppb, or from 1 ppb to 50 ppb boron;
(vii) 0 parts per million (ppm), or from greater than 0 ppm to 5 ppm, or from 1 ppm to 3 ppm fluorine; and/or
(viii) 0 ppm chromium or from greater than 0 ppb to less than 100 ppb chromium; and/or
(ix) an I₂ value from 0.6 g/10 min to 1.2 g/10 min, or from 0.7 g/10 min to 1.1 g/10 min); and/or
(x) a terminal vinyl content from 0.22/1000C to 0.70/1000C, or from 0.22/1000C to 0.50/1000, or from 0.23/1000C to 0.4/1000C; and/or
(xi) a total unsaturation from 0.25/1000C to 1.0/1000C, or from 0.25/1000C to 0.45/1000C, or from 0.25/1000C to 0.40/1000C (hereafter composition1); and
   (B) from 0.5 wt % to 2.0 wt %, or from 1.0 wt % to 1.5 wt % of the hydrolyzed silane monomer, or hydrolyzed silane monomer formed from vinyltrimethoxysilane. The insulation layer has one, some, or all of the following properties:
(1) a surface roughness Ra value from 50μ-in to 150μ-in, and/or
(2) a dissipation factor less than or equal to 0.0001 radians, and/or
(3) a dielectric constant from 2.0 to less than 2.29, and/or
(4) a volume resistivity from 5.00 E+16 to 8.00 E+17, and/or
(5) a hot creep value from 20% to 30%, and
any combination of (1)-(5).

A “conductor,” as used herein, is one or more wire(s) or fiber(s) for conducting heat, light, and/or electricity. The conductor may be a single wire/fiber or a multi-wire/fiber and may be in strand form or in tubular form. Non-limiting examples of suitable conductors include metals such as silver, gold, copper, carbon, and aluminum. The conductor may also be an optical fiber made from either glass or plastic.

A “cable,” as used herein, is at least one wire or optical fiber within a sheath, e.g., an insulation layer or a protective outer jacket. Typically, a cable is two or more wires or two or more optical fibers bound together, typically in a common insulation layer or covering and/or protective jacket. The individual wires or fibers inside the sheath may be bare, covered or insulated. Combination cables may contain both electrical wires and optical fibers. The cable can be designed for telecommunication applications. The cable can be designed for low, medium, and/or high voltage applications. Alternating current cables can be prepared according to the present disclosure, which can be low voltage, medium voltage, high voltage, or extra-high voltage cables. Further, direct current cables can be prepared according to the present disclosure, which can include high or extra-high voltage cables. Insulated electrical conductors normally include a conductive core covered by an insulation layer. The conductive core can be solid or braided (for example, a bundle of threads). Some insulated electrical conductors may also contain one or more additional elements, such as a semiconductor layer (or layers) and/or a protective cover (for example, coiled wire, tape or sheath). Examples are coated metal wires and electrical cables, including those for use in low voltage (“LV”, 0 to <5 kilovolts (kV) electricity distribution/transmission applications), medium voltage (“MV”, 5 to <69 kV), high voltage (“HV”, 69 to 230 kV) and extra-high voltage (“EHV”, >230 kV). Power cable assessments can use AEIC/ICEA standards and/or IEC test methods.

The cable includes the conductor and the insulation layer on, or otherwise surrounding, the conductor. The insulation layer includes the silane crosslinked polyethylene composition (as previously disclosed herein) composed of (A) base bimodal ethylene/C₄-C₈ α-olefin copolymer, and (B) the hydrolyzed silane monomer. In an embodiment, the silane crosslinked polyethylene composition insulation layer directly contacts the conductor. The term “directly contacts” refers to a layer configuration whereby the insulation layer is located immediately adjacent to the conductor and no intervening layers or no intervening structures are present between the conductor and the insulation layer. Alternatively, the insulation layer indirectly contacts the conductor.

By way of example, and not limitation, some embodiments of the present disclosure will now be described in detail in the following Examples.

### Examples

1. Polymerization of the Base Bimodal Ethylene/C₄-C₈ α-Olefin Copolymer

All raw materials (monomer and comonomer) and the process solvent (a narrow boiling range high-purity isoparaffinic solvent, Isopar-E) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressurized to above reaction pressure. All reaction feed flows are measured with mass flow meters and independently controlled with computer automated valve control systems.

A two reactor system is used in a series configuration. The first continuous solution polymerization reactor consists of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to the first reactor (solvent, ethylene monomer, octene comonomer, and hydrogen) is temperature controlled to maintain a single solution phase by passing the feed stream through a heat exchanger. The total fresh feed to the first polymerization reactor is injected into the reactor at three locations with approximately equal reactor volumes between each injection location. The fresh feed is controlled with each injector receiving one third of the total fresh feed mass flow. The catalyst components are injected into the polymerization reactor at two different locations with similar reactor volumes between each injection location. The primary catalyst component feed is computer controlled to maintain the reactor monomer conversion at the specified target. The cocatalyst component is fed to maintain a specified AI concentration in the reactor. Immediately following each reactor feed or catalyst injection location, the streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the reactor loop is provided by a pump.

The second continuous solution polymerization reactor consists of a liquid full, non-adiabatic, isothermal, circulating, loop reactor which mimics a continuously stirred tank reactor (CSTR) with heat removal. Independent control of all fresh solvent, ethylene monomer, octene comonomer, hydrogen, and catalyst component feeds is possible. The total fresh feed stream to the second reactor (solvent, ethylene monomer, octene comonomer, and hydrogen) is temperature controlled by passing the feed stream through a heat exchanger. The total fresh feed to the second polymerization reactor is injected into the reactor at two locations with approximately equal reactor volumes between each injection location. The fresh feed is controlled with each injector receiving half of the total fresh feed mass flow. The catalyst components are injected into the polymerization reactor through injection stingers. The primary catalyst component feed is computer controlled to maintain the reactor monomer conversion at the specified target. The cocatalyst component is fed based on calculated specified molar ratios to the primary catalyst component. Immediately following each reactor feed injection location, the streams are mixed with the circulating polymerization reactor contents with static mixing elements. The contents of the reactor are continuously circulated through heat exchangers responsible for removing much of the heat of reaction and with the temperature of the coolant side responsible for maintaining an isothermal reaction environment at the specified temperature. Circulation around the second reactor loop is provided by a pump.

The effluent from the first polymerization reactor (containing solvent, ethylene monomer, octene comonomer, hydrogen, catalyst components, and polymer) exits the first reactor and is added to the second reactor. Upon exiting the second reactor loop, the second/final reactor effluent enters a post-reactor adiabatic pipe, with a total volume approximately 21.4% that of the two loop reactors combined, where the reaction continues for a period prior to entering a mixing zone where it is deactivated with the addition of and reaction with a suitable reagent (water). At this same reactor exit location other additives are added for polymer stabilization during production and extrusion like Tetrakis(Methylene (3,5-Di-Tert-Butyl-4-Hydroxyhydrocinnamate)) Methane.

Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

The reactor stream feed data flows that correspond to the values in Table 1A used to produce the examples are graphically described in FIG. 2. The data are presented such that the complexity of the solvent recycle system is accounted for and the reaction system can be treated more simply as a once through flow diagram. Polymerization conditions are provided in Table 1A below, and the catalyst and cocatalyst components are described in Table 1B below.

Table 1A below provides polymerization conditions for comparative samples (“CS”) and inventive examples (“IE”), ethylene monomer, octene comonomer. In Table 2A, comparative sample 1 is DFDA-7530 NT, and comparative sample 2 is DFDK-6050 NT.

TABLE 1A
Polymerization conditions

| Sample | Units | Comparative 3 | Inventive 1 | Inventive 2 | Inventive 3 | Inventive 4 | Inventive 5 |
|---|---|---|---|---|---|---|---|
| First Reactor Feed Solvent/Ethylene | g/g | 7.3 | 7.2 | 6.7 | 7.2 | 7.2 | 5.7 |
| Mass Flow Ratio | | | | | | | |
| First Reactor Feed Comonomer/ | g/g | 0.53 | 0.61 | 0.73 | 0.60 | 0.59 | 0.91 |
| Ethylene Mass Flow Ratio | | | | | | | |
| First Reactor Feed Hydrogen/ | g/g | 1.1E−04 | 6.0E−05 | 5.4E−05 | 5.5E−05 | 3.6E−05 | 2.0E−04 |
| Ethylene Mass Flow Ratio | | | | | | | |
| First Reactor Temperature | ° C. | 165 | 165 | 165 | 165 | 175 | 160 |
| First Reactor Pressure | barg | 34 | 34 | 35 | 35 | 34 | 34 |
| First Reactor Ethylene Conversion | % | 81.6 | 82.1 | 74.2 | 81.7 | 81.0 | 65.8 |
| First Reactor Catalyst Type | Type | Catalyst A | Catalyst A | Catalyst A | Catalyst A | Catalyst A | Catalyst B |
| First Reactor Co-Catalyst 1 Type | Type | Co-cat A | Co-cat A | Co-cat A | Co-cat B | Co-cat B | Co-cat B |
| First Reactor Co-Catalyst 1 | ppm Al | 2.0 | 2.3 | 1.8 | 1.5 | 1.5 | 1.4 |
| Reactor Concentration | | | | | | | |
| First Reactor Residence Time | min | 14.3 | 14.3 | 13.3 | 14.2 | 14.0 | 12.8 |
| Percentage of Total Ethylene | wt % | 45.9% | 45.9% | 45.6% | 46.0% | 46.0% | 55.8% |
| Feed to First Reactor | | | | | | | |
| Second Reactor Feed Solvent/ | g/g | 1.7 | 1.7 | 1.7 | 1.7 | 1.7 | 1.4 |
| Ethylene Mass Flow Ratio | | | | | | | |
| Second Reactor Feed Comonomer/ | g/g | 0.066 | 0.079 | 0.112 | 0.076 | 0.077 | 0.161 |
| Ethylene Mass Flow Ratio | | | | | | | |
| Second Reactor Feed Hydrogen/ | g/g | 4.99E−04 | 1.06E−03 | 1.07E−03 | 1.14E−03 | 1.10E−03 | 1.07E−03 |
| Ethylene Mass Flow Ratio | | | | | | | |
| Second Reactor Temperature | ° C. | 200 | 200 | 200 | 200 | 200 | 200 |
| Second Reactor Pressure | barg | 34 | 34 | 34 | 34 | 34 | 34 |
| Second Reactor Ethylene Conversion | % | 77.7 | 78.0 | 78.3 | 77.8 | 78.2 | 84.2 |
| Second Reactor Catalyst Type | Type | Catalyst C | Catalyst C | Catalyst C | Catalyst C | Catalyst C | Catalyst D |
| Second Reactor Co-Catalyst 1 Type | Type | Co-cat C | Co-cat C | Co-cat C | Co-cat C | Co-cat C | Co-cat B |
| Second Reactor Co-Catalyst 1 to | mol/mol | 4.0 | 4.0 | 4.0 | 4.0 | 4.0 | n/a |
| Catalyst Molar Ratio | | | | | | | |
| Second Reactor Co-Catalyst 1 | ppm Al | n/a | n/a | n/a | n/a | n/a | 1.4 |
| Reactor Concentration | | | | | | | |
| Second Reactor Residence Time | min | 5.6 | 5.6 | 5.2 | 5.6 | 5.6 | 5.6 |
| Post Reactor Ethylene Conversion | % | 50.0 | 50 | 50.5 | 48.5 | 48.0 | 52.5 |

TABLE 1B
Catalysts used from Table 1A

| | |
|---|---|
| Catalyst A | 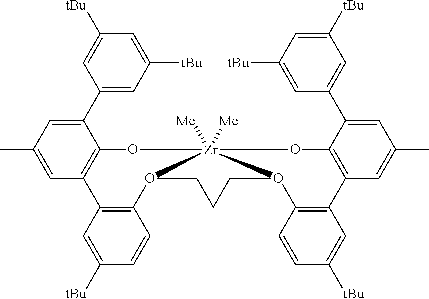 |
| Catalyst B | 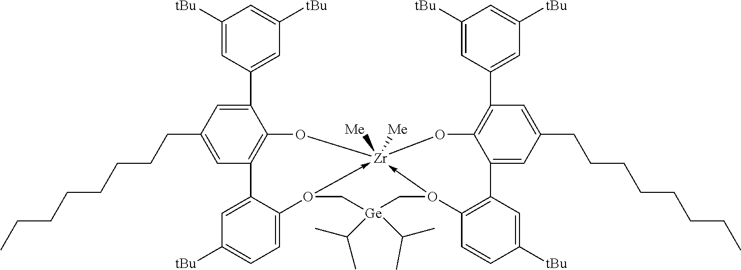 |
| Catalyst C | A Ziegler-Natta type catalyst. The heterogeneous Ziegler-Natta type catalyst-premix was |
| | prepared substantially according to U.S. Pat. No. 4,612,300, by sequentially adding to a |
| | volume of ISOPAR E, a slurry of anhydrous magnesium chloride in ISOPAR E, a solution of |
| | EtAlCl₂ in heptane, and a solution of Ti(O—iPr)₄ in heptane, to yield a composition containing a |
| | magnesium concentration of 0.20M and a ratio of Mg/Al/Ti of 40/12.5/3. An aliquot of this |
| | composition was further diluted with ISOPAR-E to yield a final concentration of 500 ppm Ti in |
| | the slurry. An aliquot of this composition can be further diluted with ISOPAR-E if required. |
| | While being fed to, and prior to entry into the polymerization reactor, the catalyst premix was |
| | contacted with a dilute solution of Et3Al, in the molar Al to Ti ratio specified in Table 1A, to |
| | give the active catalyst. |
| Catalyst D | 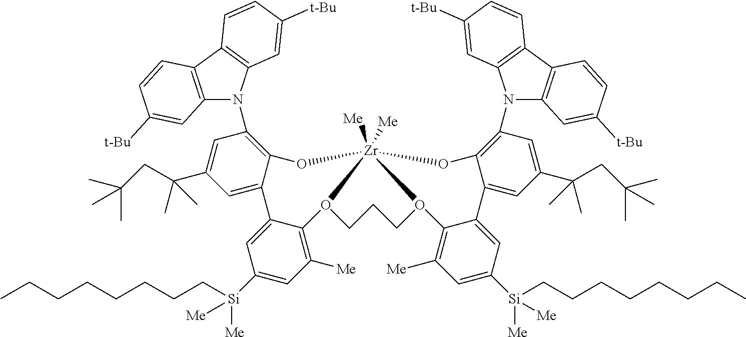 |
| Co-cat A | A hydrocarbon-soluble, iso-butyl modified-methylaluminoxane in heptane. The iso-butyl to |
| | methyl ratio is approximately 1:2 and the total free trialkylaluminum content is approximately |
| | 40% of the total Al present in the mixture. |
| Co-cat B | A hydrocarbon-soluble, n-octyl modified-methylaluminoxane in Isopar E. The octyl to methyl |
| | ratio is approximately 1:6 and the total free trialkylaluminum content is approximately 15% of |
| | the total Al present in the mixture. |
| Co-cat C | Tri-ethyl aluminum |

Properties for the base bimodal ethylene/α-olefin C₄-C₈ α-olefin are provided in Tables 2A and 2B below.

TABLE 2A
Unsaturation Properties for CS1-3 and IE 1-5.

| | Octene | | cis&trans | | | | Terminal | Max Internal |
|---|---|---|---|---|---|---|---|---|
| | (mol %) | Vinyl^{$} | vinylenes^{$} | trisubstituted^{$} | Vinylidenes^{$} | total unsat^{$} | (Vinyls + Vd) | (Trisub + Vinylenes) |
| CS1^{@} | 4.00%* | 0.76 | 0.207 | 0.048 | 0.249 | 1.27 | 1.01 | 0.26 |
| CS2\hat{ } | 2.71% | 0.18 | 0.031 | 0.023 | 0.031 | 0.27 | 0.21 | 0.05 |
| CS3 | 2.82% | 0.19 | 0.013 | 0.008 | 0.020 | 0.24 | 0.21 | 0.02 |
| IE1 | 3.18% | 0.21 | 0.015 | 0.009 | 0.023 | 0.25 | 0.23 | 0.02 |
| IE2 | 3.15% | 0.23 | 0.018 | 0.010 | 0.028 | 0.29 | 0.26 | 0.03 |
| IE3 | 3.20% | 0.21 | 0.015 | 0.010 | 0.026 | 0.27 | 0.24 | 0.03 |
| IE4 | 3.07% | 0.22 | 0.016 | 0.016 | 0.032 | 0.28 | 0.25 | 0.03 |
| IE5 | 3.26% | 0.33 | 0.043 | 0.017 | 0.005 | 0.40 | 0.34 | 0.06 |

*butene comonomer (all other samples octene comonomer)
^{$}per 1000C
^{@}CS1 is DFDA-7530 NT
\hat{ }CS2 is DFDK-6050 NT

TABLE 2B
Properties for CS1-3 and IE1-5

| | | | | | | | | | 0.1 | 100 | | | | | |
|---|---|---|---|---|---|---|---|---|---|---|---|---|---|---|---|
| | Octene | Density | | | | | | | rad/s | rad/s | | | F | B | Ra |
| | (mol %) | (g/cm³) | Mn^{%} | Mw^{%} | Mz | Mw/Mn | I₂ | I₂₁/I₂ | (Pas) | (Pas) | SHI^{#} | Cr (ppb) | (ppm) | (ppb) | (μ in) |
| CS1^{@} | 4.00%* | 0.921 | 11578 | 119827 | 936116 | 10.35 | 0.57 | 83.2 | 20710 | 1033 | 20.0 | 440 ± 40 | <3 | <80 | 161 |
| CS2\hat{ } | 2.71% | 0.9205 | 16736 | 103508 | 303331 | 6.18 | 0.86 | 52.8 | 14072 | 1276 | 11.0 | <100 | 7 | <80* | 125 |
| CS3 | 2.82% | 0.9207 | 22100 | 99935 | 263242 | 4.52 | 0.71 | 53.4 | 17527 | 1205 | 14.5 | <100 | <3 | <80 | 331 |
| IE1 | 3.18% | 0.9207 | 14283 | 101621 | 319565 | 7.11 | 0.79 | 97.2 | 22280 | 976 | 22.8 | <100 | <3 | <80 | 117 |
| IE2 | 3.15% | 0.9206 | 13290 | 98871 | 327703 | 7.44 | 1.03 | 94.8 | 16514 | 874 | 18.9 | <100 | <3 | <80 | 113 |
| IE3 | 3.20% | 0.9206 | 14066 | 98910 | 311097 | 7.03 | 0.84 | 98.6 | 20859 | 926 | 22.5 | <100 | <3 | <80 | 121 |
| IE4 | 3.07% | 0.9215 | 13905 | 98504 | 310120 | 7.08 | 0.76 | 106.1 | 23791 | 922 | 25.8 | <100 | <3 | <80 | 141 |
| IE5 | 3.26% | 0.9208 | 10308 | 109042 | 381169 | 10.58 | 0.86 | 129.1 | 10010 | 1057 | 9.5 | <100 | <3 | <80 | 54 |

*Butene comonomer,
^{%}g/mol,
^{#}η0.1/η100
⁺Ra was measured on cable jacket extruded onto wire.
^{@}CS1 is DFDA-7530 NT
\hat{ }CS2 is DFDK-6050 NT

### 2. Silane Crosslinking

MONOSIL formulations were mixed by first soaking the VTMS (UniqueChem) and 0.1 wt % Luperox 101 (Arkema) into pellets of the base resins and then extruding those pellets with pellets of the catalyst (DFDA-5481 from Dow) on a Brabender single screw extruder with a double mixing head at 150° F./170° F./190° F./195° F., 40 rpm, and a 40/40 mesh screen pack. The resulting 4 inch wide and 50 mil thick tapes (replicating insulation layer) were then cured in a water bath at 90° C. for 4 hours.

Properties of the insulation layer composed of silane crosslinked polyethylene composition are provided in Table 3 below.

TABLE 3
Properties for insulation layer

| | | | Base | | DFDA-5481 | Luperox | | Hot | | | |
|---|---|---|---|---|---|---|---|---|---|---|---|
| | | | Resin | VTMS | NT | 101 | Ra | Creep | | DF | |
| | I₂ | I₂₁/I₂ | (wt %) | (wt %) | (wt %) | (wt %) | (μ in) | (%) | DC | (radians) | Resistivity^{&} |
| CS1 | 0.57 | 83.2 | 93.5% | 1.48% | 4.92% | 0.1 | 161 | 21% | 2.2824 | 0.0002 | 1.70E+17 |
| CS2 | 0.86 | 52.8 | 93.5% | 1.48% | 4.92% | 0.1 | 125 | 19% | 2.2917 | 0.0001 | 2.85E+16 |
| CS3 | 0.71 | 53.4 | 93.5% | 1.48% | 4.92% | 0.1 | 331 | 18% | 2.2903 | 0.0001 | 1.54E+17 |
| IE 1 | 0.79 | 97.2 | 93.5% | 1.48% | 4.92% | 0.1 | 117 | 21% | 2.2830 | 0.0001 | 8.64E+16 |
| IE 2 | 1.03 | 94.8 | 93.5% | 1.48% | 4.92% | 0.1 | 113 | 26% | 2.2872 | 0.0001 | 4.78E+17 |
| IE 3 | 0.84 | 98.6 | 93.5% | 1.48% | 4.92% | 0.1 | 121 | 25% | 2.2824 | 0.0001 | 1.49E+17 |
| IE 4 | 0.76 | 106.1 | 93.5% | 1.48% | 4.92% | 0.1 | 141 | 26% | 2.2834 | 0.0001 | 6.36E+16 |
| IE 5 | 0.86 | 129.1 | 93.5% | 1.48% | 4.92% | 0.1 | 54 | 26% | 2.2785 | 0.0001 | 5.91E+17 |

^{&}ohm/cm

The high electrical resistivity for Inventive Examples 1-5 (greater than 5.0×10¹⁶) makes the Inventive Examples 1-5 suitable for electrical insulation unlike the lower electrical resistivity of the CS2 (2.85×10¹⁶). The fluorine is present (7 ppm) in CS2 in Table 2B, whereas each of IE 1-5 has no fluorine (<3 ppm or 0 ppm). CS2 also has the highest dielectric constant (2.2917) compared to IE 1-5 dielectric constant range from 2.2785 to 2.2874. Despite the different catalyst activator, the vinyl content (from Table 2A) in each of IE1-5 (0.21-0.33) exceeds the vinyl content for CS2 (0.18). Surprisingly, the lower vinyl content in each of IE1-5 (0.21-0.33) compared to the vinyl content of CS1 (0.76) also had little effect on the crosslinking, as measured by hot creep. Hot creep values for each of IE1-5 are below 30%, which indicates a high degree of crosslinking.

The wide molecular weight distributions (Mw/Mn) for each of IE1-5 (7.03-10.58) are much larger than the Mw/Mn for CS2 (6.18) and CS3 (4.52). The IE1-5 Mw/Mn (7.03-10.58) approaches and surpasses that of the gas phase LLDPE in CS1 (10.35). The gas phase synthesis of CS1 is confirmed by its chromium content (440 ppm) in Table 2B, whereas each of IE1-5 has no chromium (less than 100 ppm Cr, or 0 ppm Cr). Nonetheless, the wide Mw/Mn achieved for each of IE1-5 (7.03-10.58) provides the high shear thinning, as seen in the high values of η_{0.1}/η₁₀₀, (9.5-25.8) for IE1-5, and seen in the high melt flow ratios (I₂₁/I₂) for each of IE1-5 (94.8-129.1) compared to the I₂₁/I₂ ratio for CS2 (52.8) and CS3 (53.4) as well as the I₂₁/I₂ ratio for the gas phase LLDPE in CS1 (83.2). The effect of this shear thinning can be seen in the surface roughness in the extruded tapes (simulating insulation layer). The surface roughness, as measured by the average roughness height (Ra), is much lower for each of IE1-5 (55-141μ-in) compared to the surface roughness of CS3.

It is specifically intended that the present disclosure not be limited to the embodiments and illustrations contained herein, but include modified forms of those embodiments including portions of the embodiments and combination of elements of different embodiments as come within the scope of the following claims

1. An insulation layer comprising:
a silane crosslinked polyethylene composition comprising
(A) from 90 wt % to 99 wt % of a base bimodal ethylene/C₄-C₈ α-olefin copolymer, the base ethylene/C₄-C₈ α-olefin copolymer prior to silane crosslinking, having
(i) a density from 0.91 g/cc to 0.93 g/cc,
(ii) an I₂₁/I₂ ratio from 90 to 140,
(iii) an Mw/Mn from 7.0 to 15.0,
(iv) an SHI (n0.1/n100) value from 5.0 to 30.0,
(v) from 0 ppb to 80 ppb boron, and
(vi) from 0 ppm to 5 ppm of fluorine;
(B) from 0.5 wt % to 2.0 wt % of a hydrolyzed silane monomer;
the insulation layer having a property selected from the group consisting of
(1) a surface roughness Ra value from 50μ-in to 150μ-in,
(2) a dissipation factor less than or equal to 0.0001 radians,
(3) a dielectric constant from 2.0 to less than 2.29,
(4) a volume resistivity from 5.00×10¹⁶ to 8.00×10¹⁷,
(5) a hot creep value from 20% to 30%,
and combinations thereof.

2. The insulation layer of claim 1 wherein the bimodal ethylene/C₄-C₈ α-olefin copolymer prior to silane crosslinking has a melt index, I₂, from 0.6 g/10 min to 1.2 g/10 min.

3. The insulation layer of claim 1 wherein the bimodal ethylene/C₄-C₈ α-olefin copolymer has a property selected from the group consisting of
a terminal vinyl content from 0.22/1000C to 0.70/1000C,
a total unsaturation from 0.25/1000C to 1.0/1000C, and
combinations thereof.

4. The insulation layer of claim 1 wherein the bimodal ethylene/C₄-C₈ α-olefin copolymer has an Mz less than 600,000 g/mol.

5. The insulation layer of claim 1 wherein the insulation layer comprises 0 ppb boron.

6. The insulation layer of claim 1 wherein the insulation layer comprises 0 ppm fluorine.

7. The insulation layer of claim 1 wherein the hydrolyzed silane monomer is formed from vinyltrimethoxysilane.

8. The insulation layer of claim 1 wherein the insulation layer comprises from 3 wt % to 6 wt % of a second ethylene-based polymer.

9. A cable comprising:
a conductor; and
an insulation layer on the conductor, the insulation layer comprising
a silane crosslinked polyethylene composition comprising
(A) from 90 wt % to 99 wt % of a base bimodal ethylene/C₄-C₈ α-olefin copolymer, the base bimodal ethylene/C₄-C₈ α-olefin copolymer prior to silane crosslinking, having
(i) a density from 0.91 g/cc to 0.93 g/cc,
(ii) an I₂₁/I₂ ratio from 90 to 140,
(iii) an Mw/Mn from 7.0 to 15.0,
(iv) an SHI (n0.1/n100) value from 5.0 to 30.0; and
(B) from 0.5 wt % to 2.0 wt % of a hydrolyzed silane monomer.

10. The cable of claim 9 wherein the insulation layer has a property selected from the group consisting of
(1) a surface roughness Ra value from 50μ-in to 150μ-in,
(2) a dissipation factor less than or equal to 0.0001 radians,
(3) a dielectric constant from 2.0 to less than 2.29,
(4) a resistivity from 5.00×10¹⁶ to 8.00×10¹⁷,
(5) a hot creep value from 20% to 30%, and
combinations thereof.
